(19) United States
(12) Patent Application Publication
(10) Pub. No.: US 2014/0369057 A1
(43) Pub. Date: Dec. 18, 2014

(54) ILLUMINATING UNIT

(71) Applicant: YAZAKI CORPORATION, Tokyo (JP)

(72) Inventors: Takashi Wakasugi, Shizuoka (JP); Ryohei Konishi, Shizuoka (JP)

(21) Appl. No.: 14/475,913

(22) Filed: Sep. 3, 2014

Related U.S. Application Data
(63) Continuation of application No. PCT/JP2013/058179, filed on Mar. 13, 2013.

(30) Foreign Application Priority Data
Mar. 13, 2012 (JP) 2012-055619

(51) Int. Cl. F21V 23/06; F21V 19/00; F21V 23/02

(52) U.S. Cl. CPC F21V 23/06; F21V 23/023; F21V 19/004; F21Y 2101/02
USPC 362/375

(57) ABSTRACT

An illuminating unit includes an electronic component that emits illumination light, a busbar that includes a electric connecting part which electrically connects the electric component and the outside of the electronic component, and a locking part which has elasticity and sandwiches and holds the electronic component, a housing that accommodates the busbar, and a cover that is assembled to the housing and includes an opening part through which the illumination light passes. The locking part includes a contact part and a pressing part. The contact part abuts with a fringe of the opening part when the cover is assembled to the housing. The pressing part follows the contact part and presses the electronic component by being deformed in a state where the cover is assembled to the housing.

### CROSS REFERENCE TO RELATED APPLICATIONS

This application is a continuation of PCT application No. PCT/JP2013/058179, which was filed on Mar. 13, 2013 based on Japanese Patent Application (No. 2012-055619) filed on Mar. 13, 2012, the contents of which are incorporated herein by reference.

### BACKGROUND OF THE INVENTION

1. Field of the Invention

The present invention relates to an illuminating unit which includes an electronic component, busbars and a cover.

2. Description of the Related Art

In recent years, indoor illuminating devices which use LEDs (light emitting diodes) light sources come to be used for the purposes of downsizing and energy-saving in vehicles or the like. For example, an illuminating unit in which the LED is applied as a source of light is disclosed in the following PTL 1.

The illuminating unit disclosed in the following PTL 1 includes an electronic component (LED) 1 which becomes a source of light, a housing 3 on which the electronic component 1 is carried, an electronic component power supplying plate 5 which performs electrical connection from outside to the electronic component, and support shafts 6 whose two ends are fixed by a base 4 and the electronic component power supply plate 5.

In the electronic component 1, LED elements are mounted onto an electronic component substrate 8. Contacts 9 connected to the electrodes of the LED elements are formed at the two ends of the electronic component substrate 8.

The housing 3 is formed into a board-like shape, and a pair of through holes 2 are formed at the two ends of the housing 3. On the top surface of the housing 3, a recess 10, on which the electronic component 1 is carried, is formed.

The electronic component power supply plate 5 is molded of metal that has conductivity, an opening part 15 is formed roughly at the central part, and convex parts 16 are formed at the fringe of the opening part 15 toward the side of the housing 3. A power supply pattern 18 is formed on the surface of the electronic component power supply plate 5 at the side of the housing 3, and the distal ends of the convex parts 16 where the power supply pattern 18 is formed become electrical contact parts 17.

A pair of support shafts 6 are provided between the base 4 and the electronic component power supply plate 5. The housing 3 is arranged between the base 4 and the electronic component power supply plate 5 to be movable in a direction generally perpendicular to the electronic component power supply plate 5 at a state where the support shafts 6 are inserted into the through holes 2.

Furthermore, the support shafts 6 are inserted into coil-shaped springs 7 which have elasticity. The springs 7 are arranged between the housing 3 and the base 4.

With the above construction and structure, the housing 3 is pushed up to the side of the electronic component power supply plate 5 by the elasticity of the springs 7. Thereby, the contacts 9 of the electronic component substrate 8 which is carried on the housing 3 abut with the electrical contact parts 17 of the electronic component power supply plate 5, and the electronic component 1 is electrically connected to the electronic component power supply plate 5 through the contacts 9. By the elasticity of the springs 7, the electronic component 1 can be maintained in a state of being electrically connected with the electric connecting parts 17 of the electronic component power supply plate 5.

### PTL 1: JP-A-2009-200102

### SUMMARY OF THE INVENTION

In the above related art, the pair of support shafts and the springs are included in addition to the housing and the electronic component power supply plate for the purpose of electrical connection from outside to the electronic component, the contacts of the electronic component substrate abut with the electrical contact parts of the electronic component power supply plate by the elasticity that the springs have, and the electrical connection to the electronic component is maintained. Therefore, there are matters that the number of components of the illuminating unit increases, the structure is complicated, and man-hour related to the manufacture of the illuminating unit increases.

There is also a matter that the increase of the number of the components leads to the increase of the cost related to the manufacture of the illuminating unit.

The present invention is made in view of the above described circumstances, and the object of the invention is to provide an illuminating unit so that man-hour related to the manufacture is reduced and operativity is improved by adopting a simple structure and controlling the number of components, and the manufacture cost can be reduced.

(1) According to an aspect of the invention, an illuminating unit includes an electronic component that emits illumination light, a busbar that includes a electric connecting part which electrically connects the electric component and the outside of the electronic component, and a locking part which has elasticity and sandwiches and holds the electronic component, a housing that accommodates the busbar, and a cover that is assembled to the housing and includes an opening part through which the illumination light passes. The locking part includes a contact part and a pressing part. The contact part abuts with a fringe of the opening part when the cover is assembled to the housing. The pressing part follows the contact part and presses the electronic component by being deformed in a state where the cover is assembled to the housing.

According to the present invention having such a feature, the contact parts which abut with the fringe of the opening part of the cover when the cover is assembled to the housing, and pressing parts which follow the contact parts and deform (flex) to press the electronic component after the cover and the housing are assembled are formed in the locking parts. Thereby, when the electronic component is locked in the locking parts and the cover is assembled to the housing, the fringe of the opening part abuts with the contact parts formed in the locking part, and the contact parts are pushed. The electronic component is pressed inwards when the pressing parts that follow the contact parts deform (flex).

(2) In the illuminating unit of (1), a shape of a cross section of the pressing part is convex, and the pressing part is provided with a pair of slants.

According to the present invention having such a feature, the pressing parts are formed to have a generally convex cross section, and the pressing parts are provided with a pair of slants. Then, the width between the pressing parts becomes narrower than the width between the locking parts. Thereby, when the electronic component is inserted into the locking parts, the electronic component is slid on one of the slants among the pair of slants, and the pressing parts deform (flex). When the pressing parts deform (flex), the width between the pressing parts is enlarged so that the electronic component can pass. When the electronic component passes the pressing parts, the deformation (flex) of the pressing parts is reversed, and the pressing parts restore to the original shape. The other of the slants among the pair of slants abuts with the electronic component, and the electronic component is clamped by the locking parts. When the electronic component, which is locked in the locking parts, is raised, the electronic component is slid on the other of the slants so that the pressing parts deform (flex). When the pressing parts deform (flex), the width between the pressing parts is enlarged so that the electronic component can pass. When the electronic component passes the pressing parts, the electronic component is removed. The deformation (flex) of the pressing parts is reversed, and the pressing parts restore to the original shape.

(3) In the illuminating unit of (1) or (2), the contact part includes a first contact part having a first free end and a second contact part having a second free end, and a width between the first free end and the second free end is wider than a width of the opening part.

According to the present invention having such a feature, the width between one free end and the other free end of the contact parts formed to be wider than the opening part of the cover. When the cover is assembled, the free ends of the contact parts are located right under the fringe of the opening part. Thereby, when the cover is assembled to the housing, the contact parts abut with the fringe of the opening part surely, and will not pass through the opening part and project beyond the cover.

(4) In the illuminating unit of any one of (1) to (3), the fringe of the opening part at the inner side of the cover is formed into a tapered shape from a side face of the cover toward an edge of the opening part.

According to the present invention having such a feature, the fringe of the opening part of the cover at the inner side of the cover is formed into a tapered shape from the side faces of the cover toward the edge of the opening part. Thereby, when the cover is assembled to the housing, the fringe of the opening part at the inner side of the cover, which is formed into a tapered shape, abuts with the contact parts in a point-contact way.

According to the present invention described in (1), when the electronic component is locked in the locking parts and the cover is assembled to the housing, the fringe of the opening part abuts with the contact parts formed in the locking part, and the contact parts are pushed. Thus, the electronic component can be pressed inwards when the pressing parts that follow the contact parts deform (flex). Thereby, only by assembling the cover to the housing, the contact parts are pushed by the cover and the pressing parts deform (flex) to press inwards the electronic component, and the electrically connected state of the electronic component and the electric connecting parts can be maintained surely. Then, the member for maintaining a related electrically connected state needs not be produced separately, and an operation of assembling the related member becomes needless. Therefore, effects are achieved that operativity related to the manufacture is improved, and the manufacture cost can be reduced.

According to the present invention described in (2), when the electronic component is inserted into the locking parts, the electronic component is slid on one of the slants among the pair of slants, and the pressing parts deform (flex). When the pressing parts deform (flex), the width between the pressing parts is enlarged so that the electronic component can pass. When the electronic component passes the pressing parts, the deformation (flex) of the pressing parts is reversed, and the pressing parts restore to the original shape. The other of the slants among the pair of slants abuts with the electronic component, and the electronic component is sandwiched and held by the locking parts. When the electronic component, which is locked in the locking parts, is raised, the electronic component is slid on the other of the slants so that the pressing parts deform (flex). When the pressing parts deform (flex), the width between the pressing parts is enlarged so that the electronic component can pass. When the electronic component passes the pressing parts, the electronic component is removed. The deformation (flex) of the pressing parts is reversed, and the pressing parts restore to the original shape. Thereby, because the electronic component can be locked in the locking parts with a simple structure and a simple method, soldering becomes needless, and the operation of attaching the electronic component becomes easy. Further, the electronic component can be easily removed. Therefore, an effect is achieved that the manufacture-related operativity can be improved.

According to the present invention described in (3), when the cover is assembled, the free ends of the contact parts are located right under the fringe of the opening part. Thereby, when the cover is assembled to the housing, the contact parts abut with the fringe of the opening part surely, and will not pass through the opening part and project beyond the cover. Thereby, the contact parts are pushed surely, and the pressing parts deform (flex). Therefore, an effect is achieved that the electronic component can be pressed inwards more surely by the pressing parts.

According to the present invention described in (4), when the cover is assembled to the housing, the fringe of the opening part at the inner side of the cover, which is formed into a tapered shape, abuts with the contact parts in a point-contact way. Thereby, the contact parts can be pushed inwards with larger forces, in comparison with that the fringe of the opening part at the inner side of the cover is formed parallel to the fringe of the opening part on the top surface of the cover. The pressing parts deform (flex) so that the electronic component can be pressed inwards with larger forces. Therefore, an effect is achieved that an electrically connected state of the electronic component can be maintained more surely.

### BRIEF DESCRIPTION OF THE DRAWINGS

FIG. 1 is a perspective view of an illuminating unit according to the present invention.

FIG. 2 is an exploded perspective view of FIG. 1.

FIGS. 3A to 3C are a perspective view, a top view and a bottom view of the LED unit.

FIGS. 4A and 4B are a perspective view of busbars and a section view of an LED unit mounting part.

FIG. 5 is a top view of the busbars.

FIG. 6 is a perspective view of a housing.

FIGS. 7A and 7B are a perspective view and a sectional view of a cover.

FIGS. 8A and 8B show steps of assembling a unit subassembly.

FIGS. 9A and 9B show steps of assembling the unit subassembly.

FIGS. 10A and 10B are a perspective view and a side view of the unit subassembly.

FIGS. 11A and 11B are a sectional view of the unit subassembly and an enlarged sectional view of the LED unit mounting part.

FIGS. 12A and 12B are a figure which shows a step of assembling electric wires to the unit subassembly.

FIG. 13 is a figure which shows a step of assembling the cover to the unit subassembly.

FIGS. 14 and 15 are sectional views in FIG. 13.

### DETAILED DESCRIPTION OF THE EXEMPLARY EMBODIMENTS

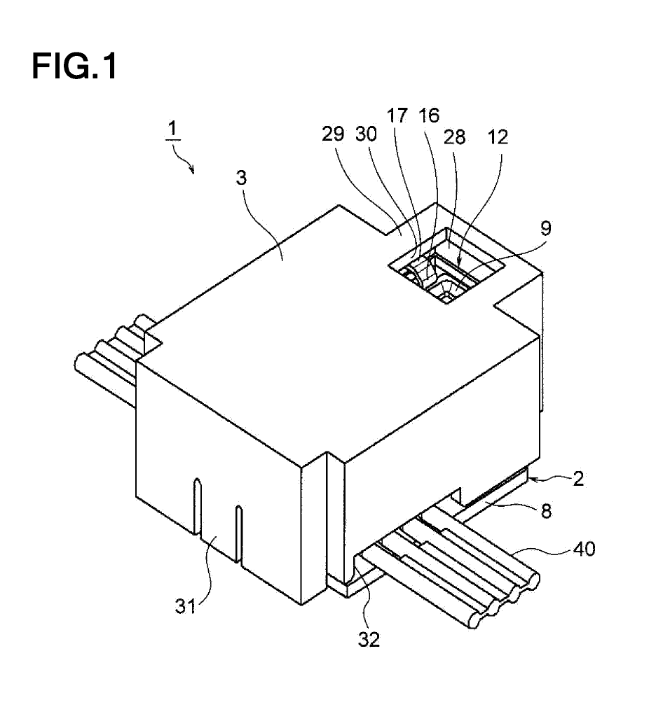

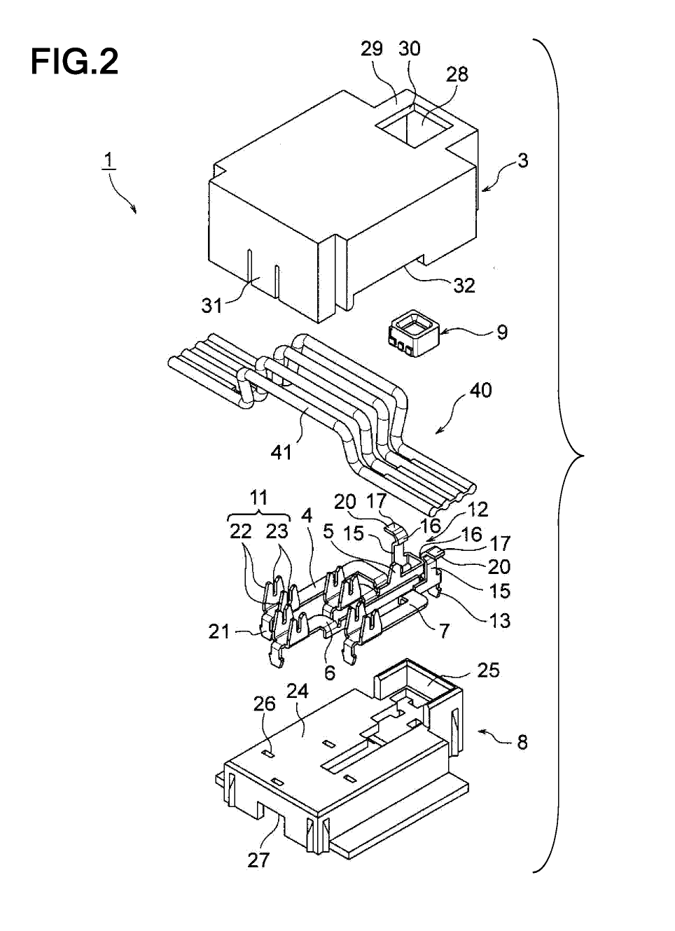

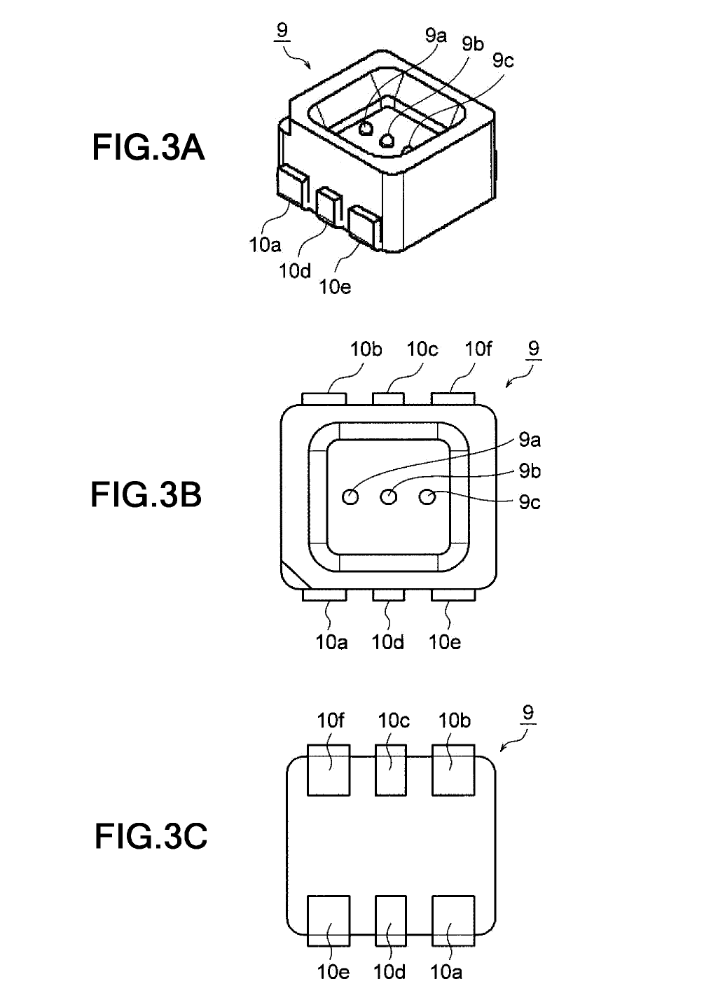

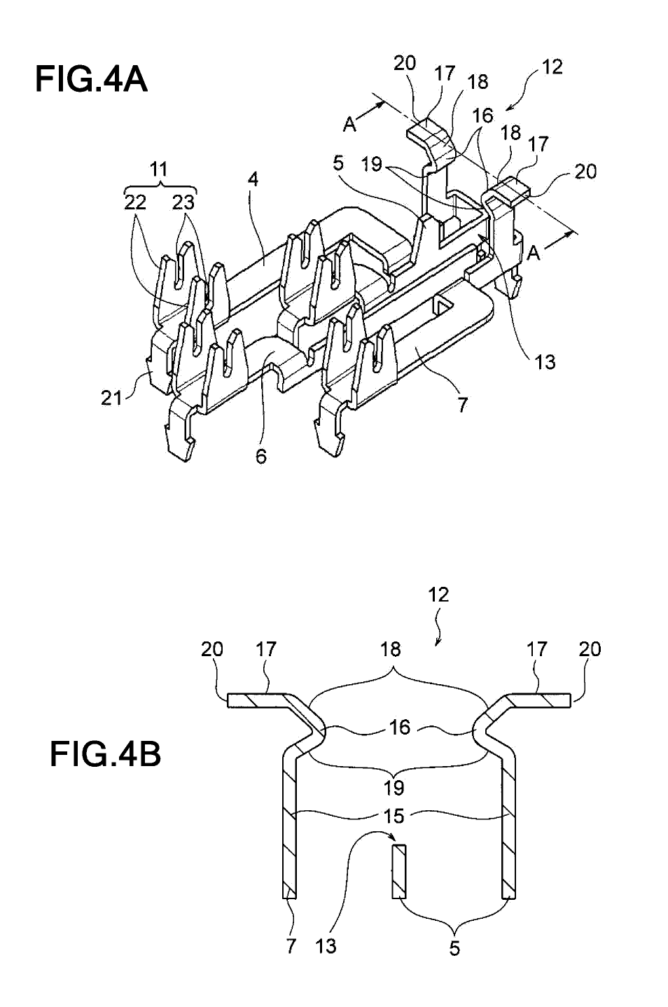

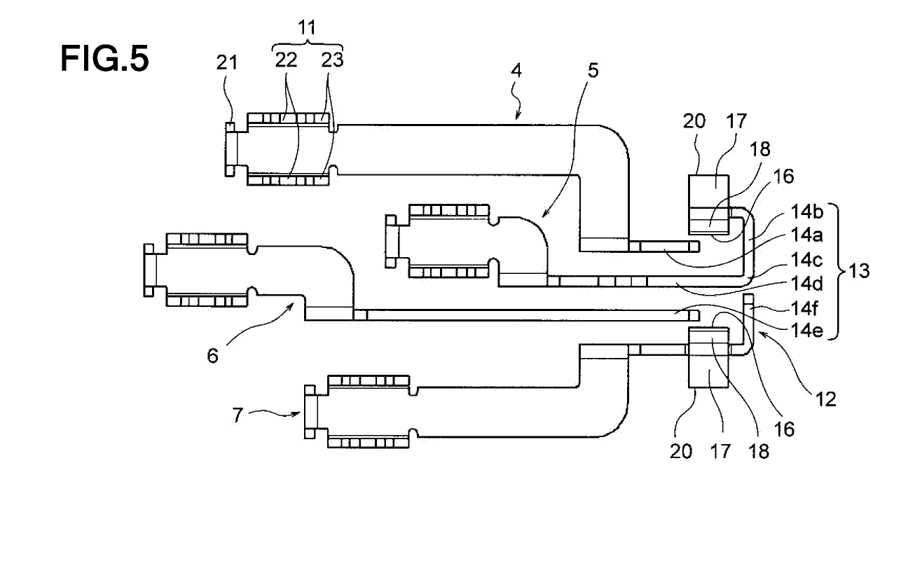

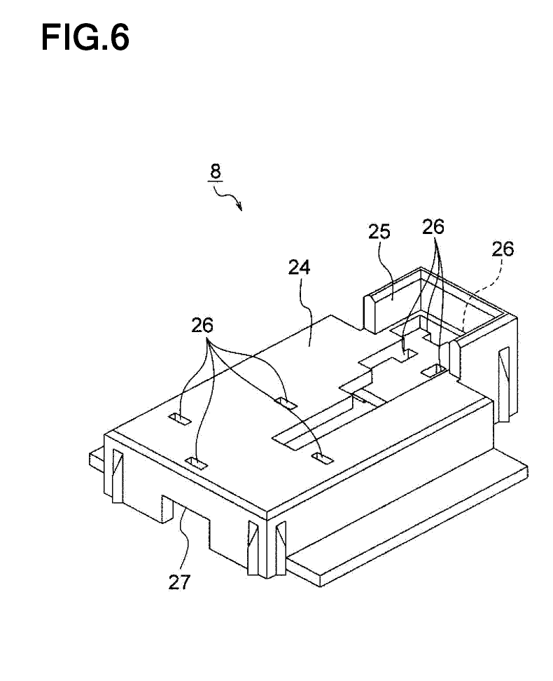

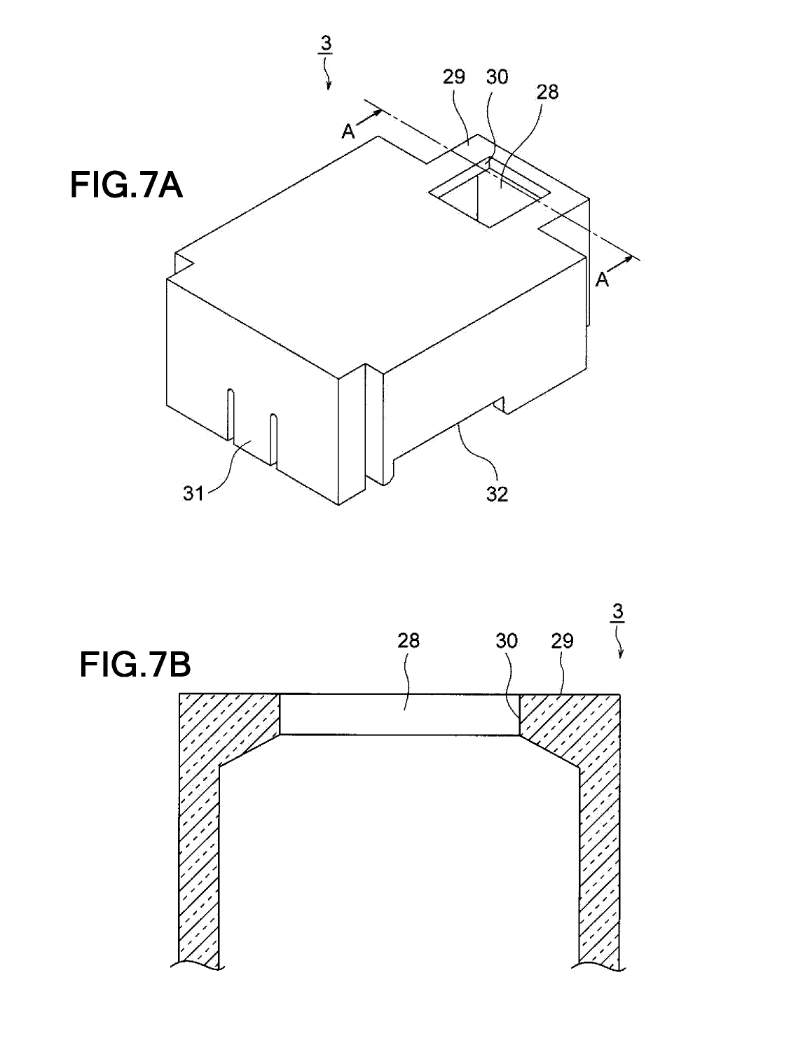

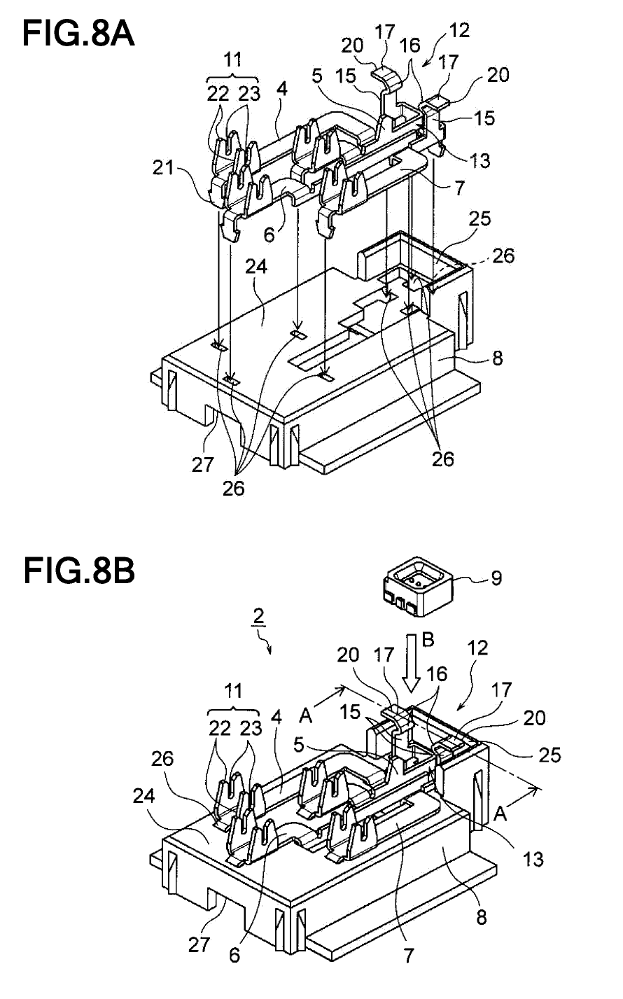

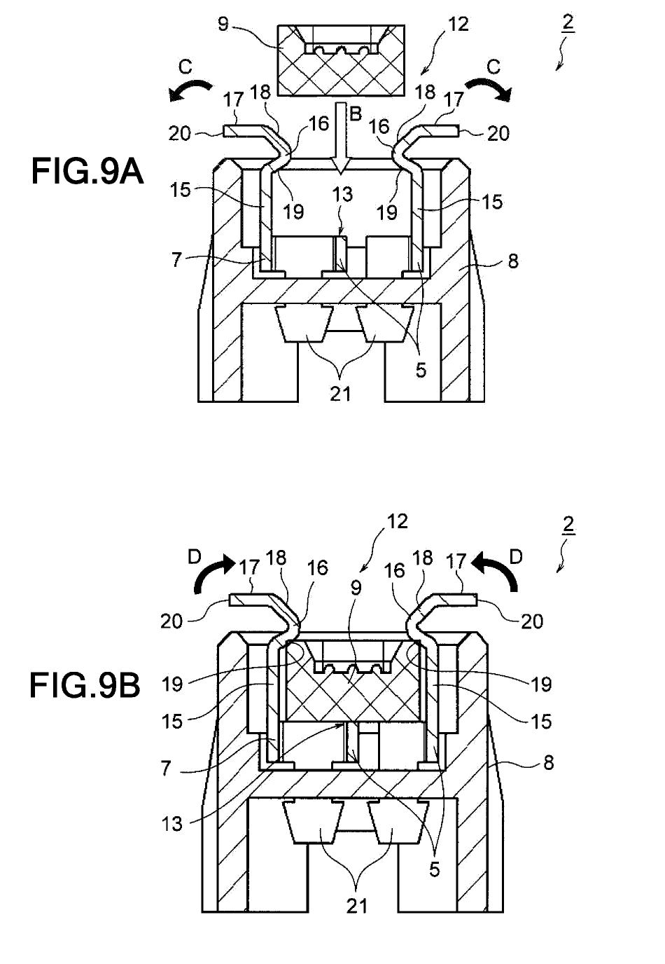

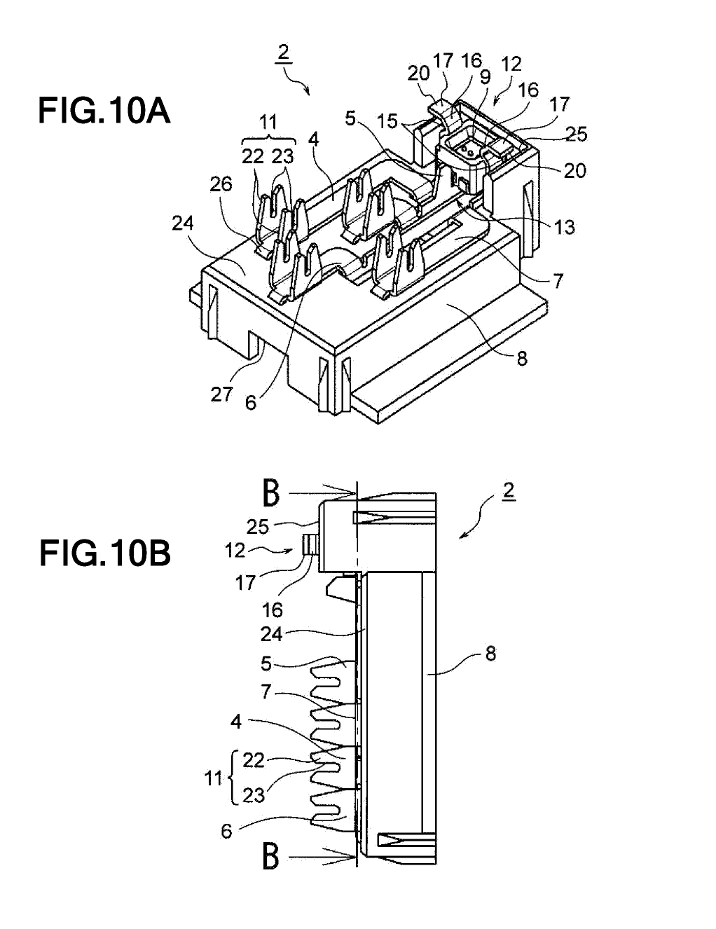

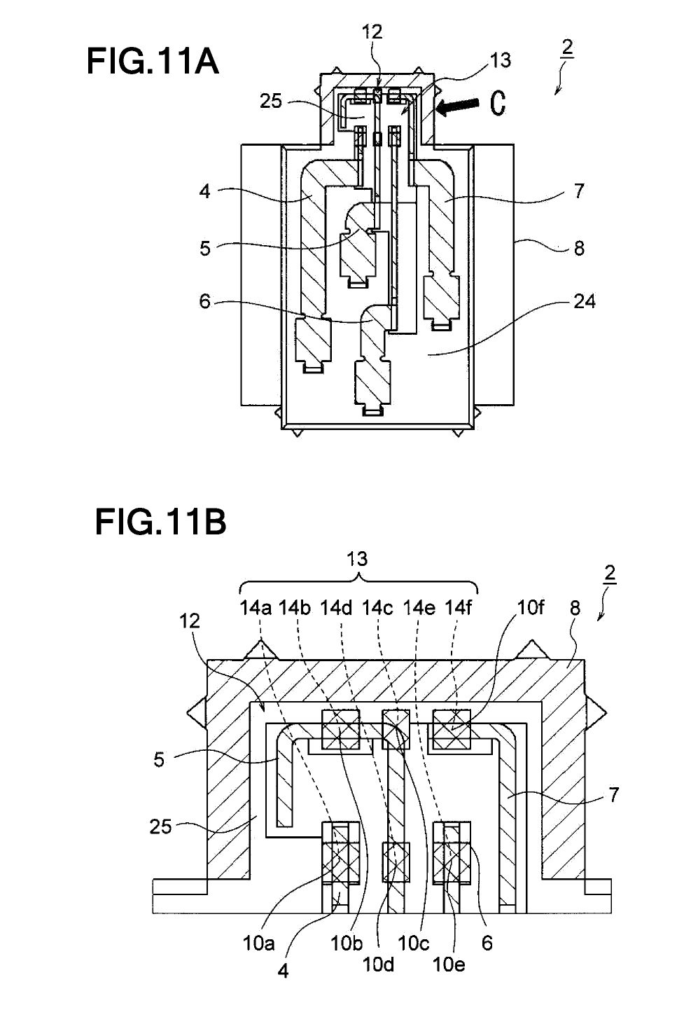

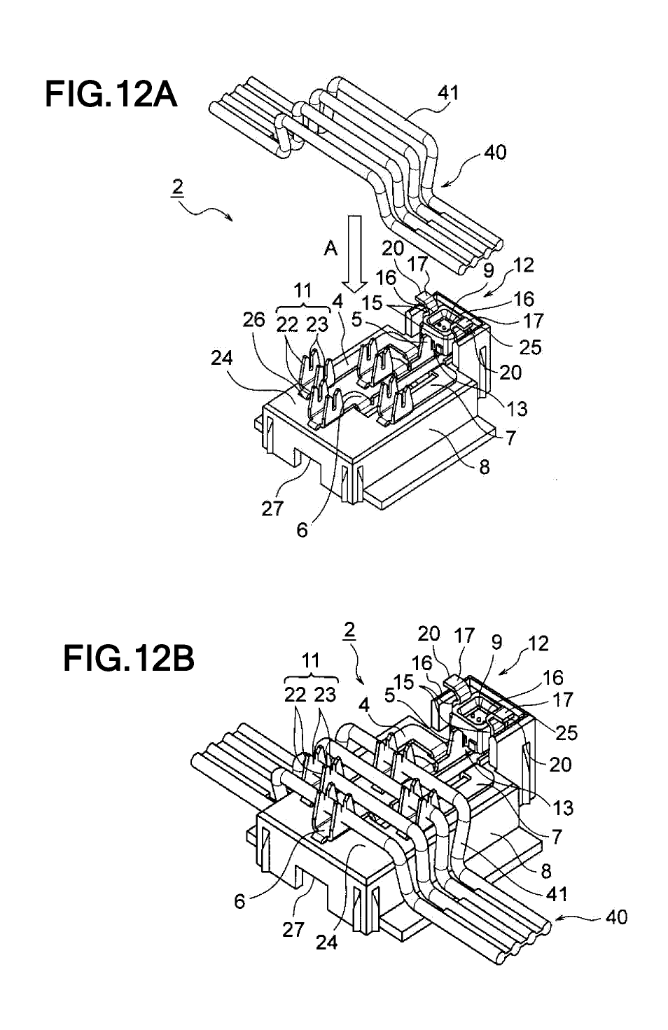

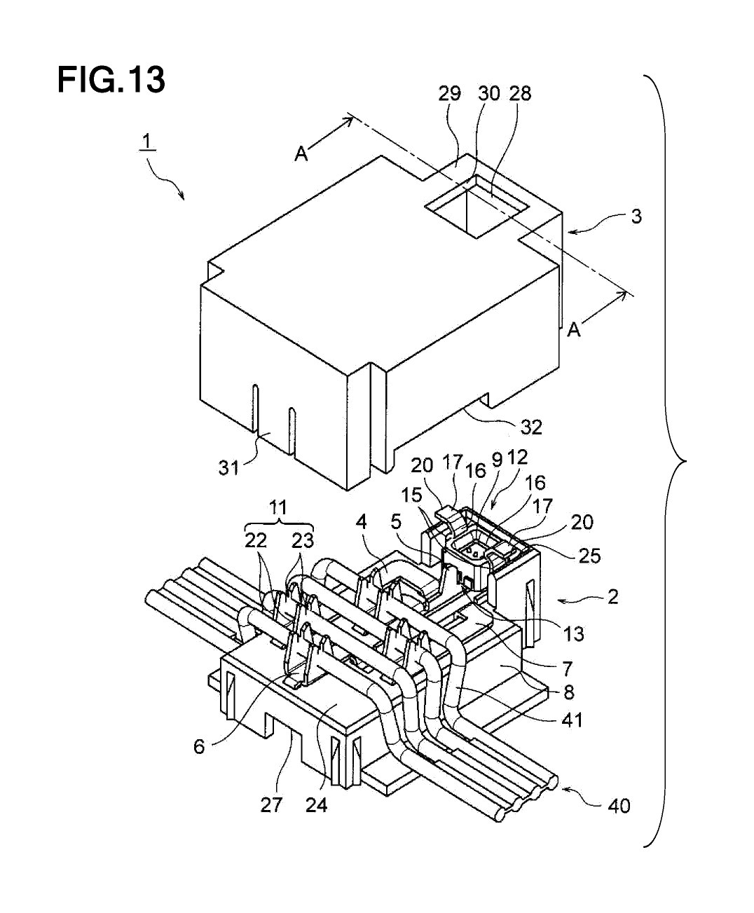

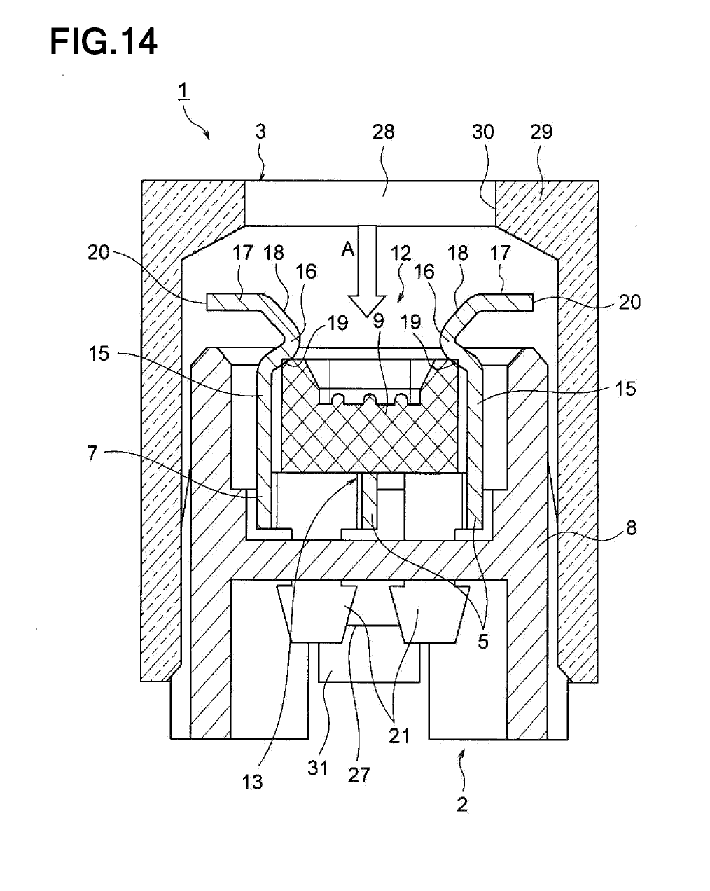

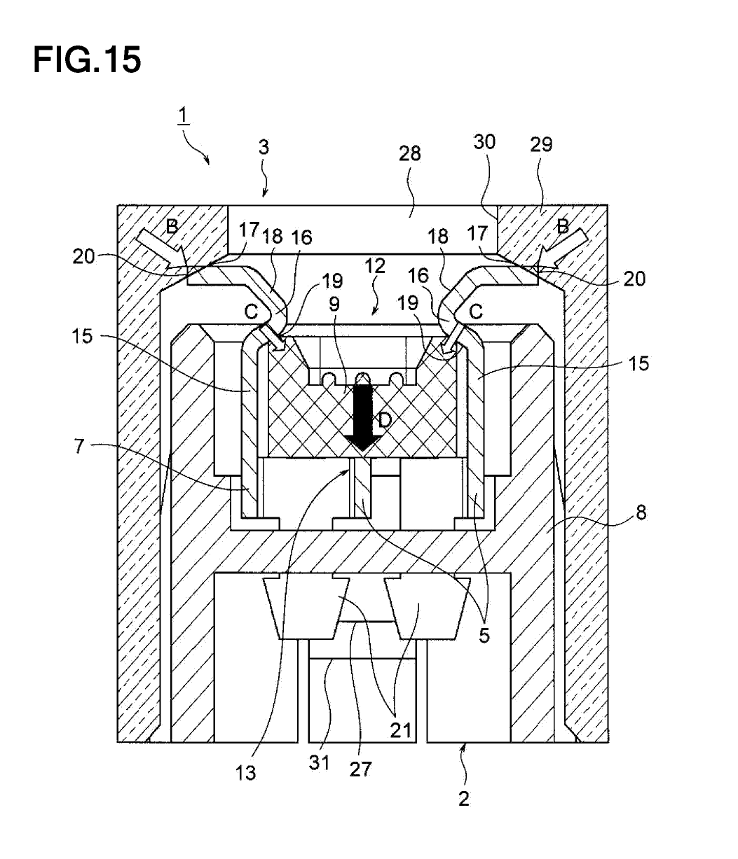

The first embodiment of the illuminating units according to the present invention is shown in FIGS. 1 to 15. FIG. 1 is a perspective view of an illuminating unit according to the present invention. FIG. 2 is an exploded perspective view of FIG. 1. FIGS. 3A to 3C include views that show an LED unit, in which FIG. 3A is a perspective view of the LED unit, FIG. 3B is a top view of FIG. 3A, and FIG. 3C is a bottom view of FIG. 3A. FIGS. 4A and 4B include views that show busbars, in which FIG. 4A is a perspective view of the busbars, and FIG. 4B is an A-A line sectional view of FIG. 4A. FIG. 5 is a top view of the busbars. FIG. 6 is a perspective view of a housing. FIGS. 7A and 7B include views that show a cover, in which FIG. 7A is a perspective view of the cover, and FIG. 7B is an A-A line sectional view of FIG. 7A. FIGS. 8A and 8B are figures which show steps of assembling a unit subassembly. FIGS. 9A and 9B are A-A line sectional views of FIG. 8B. FIGS. 10A and 10B are a perspective view and a side view of the unit subassembly. FIGS. 11A and 11B are figures which show the unit subassembly, in which FIG. 11A is a B-B line sectional view of FIG. 10A, and FIG. 11B is an expanded sectional view of the part indicated with an arrow C in FIG. 11A. FIGS. 12A and 12B is a figure which shows a step of assembling electric wires to the unit subassembly. FIG. 13 is a figure which shows a step of assembling the cover to the unit subassembly. FIG. 14 is an A-A line sectional view of FIG. 13. FIG. 15 is a figure following FIG. 14.

In FIGS. 1 and 2, a reference number 1 shows an illuminating unit of the present invention. The illuminating unit 1 is used as a component that illuminates the room of a vehicle such as an automobile, but is not be particularly limited to it. The illuminating unit 1 includes a unit subassembly 2 and a cover 3 which is assembled to the unit subassembly 2. The cover 3 is provided with an opening part 28 through which illumination light passes. Next, component members are described.

In FIG. 2, the unit subassembly 2 includes busbars 4 to 7 (in the present embodiment, four busbars), a housing 8 in which the busbars 4 to 7 are housed, and an LED unit (electronic component) 9 which is mounted to the busbars 4 to 7.

The present embodiment is described by defining the direction the cover 3 and the unit subassembly 2 in FIG. 2 line up as an “top-bottom direction”, the longitudinal direction of the busbars 4 to 7 as a “front-rear direction”, and the direction the plurality of busbars 4 to 7 line up as a “left-right direction”.

In FIG. 3A to 3C, the LED unit 9 has a plurality of LEDs 9a to 9c which emit illumination light, and LED unit side contacts 10a to 10f which perform electrical connection from outside to the LEDs 9a to 9c. In the present embodiment, the LEDs 9a to 9c in FIGS. 3A and 3B are LEDs that are made to emit light in a desired color by adjusting the ratio of red, green and blue to express full color, and are mounted on the top face of the LED unit 9. In FIG. 3C, the LED unit 9 has the LED unit side contacts 10a to 10f on the bottom side of the LED unit.

In FIGS. 4 and 5, the busbars 4 to 7 are formed into shapes as illustrated (The shape is one example.) by punching and bending metal plates having conductivity. The busbars 4 to 7 are formed to extend in the above front-back direction. The busbars 4 to 7 are arranged as shown in FIGS. 4A and 5, when the busbars 4 to 7 are accommodated in the housing 8. The busbars 4 to 7 arranged in this way have electric wire connecting parts 11 at the side of the front ends, and have an LED unit mounting part 12 at the side of the back ends. The front ends and the back ends have busbar locking parts 21, respectively. Although only the electric wire connecting parts 11 and the busbar locking part 21 of the busbar 4 are illustrated in the present embodiment, the electric wire connecting parts 11 and the busbar locking parts 21 of the busbars 5 to 7 are the same as those of the busbar 4.

In FIG. 4A, the LED unit mounting part 12 is constructed by an electric connecting part 13 and a pair of LED unit locking parts (locking parts) 15. In FIG. 5, the electric connecting part 13 is a part for an electrical connection from outside to the LED unit 9, and includes busbar side contacts 14a to 14f at the side of the back ends of the busbars 4 to 7. The busbar side contacts 14a to 14f correspond to the LED unit side contacts 10a to 10f, and used for the electrical connection from outside to the LED unit 9. Among the busbar side contacts 14a to 14f, the busbar side contacts 14b to 14d in the busbar 5 are positive side (battery side, battery is not shown in the figure), and the LEDs 9a to 9c are commonly connected to the busbar side contacts 14b to 14d. The busbar side contact 14a in the busbar 4, the busbar side contact 14e in the busbar 6 and the busbar side contact 14f in the busbar 7 become negative side (ground side, ground is not shown in the figure), and the LEDs 9a to 9c are individually connected to the busbar side contacts 14a, 14e and 14f, respectively.

In FIG. 4A, the pair of LED unit locking parts 15 have elasticity, and, are formed into an arm shape by following the back end sides of the busbars 5 and 7. The pair of LED unit locking parts 15 are formed as a part which sandwiches and holds the LED unit 9 mounted in the LED unit mounting part 12. The width of the pair of LED unit locking parts 15 is formed to be wider than the width of the LED unit 9.

In FIG. 4B, the pair of LED unit locking parts 15 have pressing parts 16 and contact parts 17 at the side where the LED unit 9 is inserted. The pressing parts 16, which have elasticity, follow the pair of LED unit locking parts 15, and are provided with a pair of slants 18 and 19 at the side where the LED unit 9 is inserted and at the side of the electric connecting part 13 while the sections of the pressing parts 16 are formed into a generally convex shape. That is, the sections of the pressing parts 16 are formed into a generally V-like shape. The vertexes of the pair of pressing parts 16 are opposed to each other. The width between the vertexes of the pressing parts 16 is formed to be smaller than the width of the LED unit 9 and the width between the pair of LED unit locking parts 15. According to the above construction and structure, if the LED unit 9 is to be locked in the pair of LED unit locking parts 15, the pressing parts 16 deform (flex) when the LED unit 9 is slid on the slants 18 of the pressing parts 16 at the side where the LED unit 9 is inserted, and inserted, and the width between the vertexes of the pressing parts 16 is enlarged so that the LED unit 9 can pass. When the LED unit 9 passes the pressing parts 16, the pressing parts 16 return to the original shapes shown in FIG. 4B by elasticity, and the width between the vertexes returns to the original width. Thereby, the LED unit 9 is locked by being sandwiched and held in the LED unit locking parts 15.

Because the LED unit 9 can be locked only with the construction and structure of the pair of LED unit locking parts 15, the LED unit 9 may be mounted in the LED unit mounting part 12 even without being soldered. Therefore, the LED unit 9 may be easily mounted. Since the LED unit 9 is slid on the slants 18 of the pressing parts 16, and pressed to enlarge the width between the pressing parts 16 so that the LED 9 is inserted into the LED unit mounting part 12, the LED unit 9 may be mounted with a relatively small force.

When the LED unit 9 is to be removed from the LED unit mounting part 12, the two ends of the top surface of the LED unit 9 are slid on the slants 19 of the pressing parts 16 at the side of the electric connecting part 13 when the LED unit 9 is raised, and the width between the vertexes of the pressing parts 16 is enlarged so that the LED unit 9 can pass. When the LED unit 9 is further raised as it is, the LED unit 9 can be removed from the LED unit mounting part 12. Therefore, the LED unit 9 can be removed with a simple method. Since the LED unit 9 is slid on the slants 19 of the pressing parts 16 and raised to enlarge the width between the pressing parts 16, the LED unit 9 can be removed with a relatively small force.

In FIG. 4B, the contact parts 17 are formed by following the pressing parts 16. The other ends of the contact parts 17 that are opposite to the ends that follow the pressing parts 16 are formed as free ends 20. In the present embodiment, the contact parts 17 are formed to extend in a direction generally perpendicular to the pair of LED unit locking parts 15 (This is only an example. In addition, for example, it is also possible that the contact parts 17 are formed to rise in an obliquely upward direction relative to the pair of LED unit locking parts 15.). The width between the free end 20 of one contact part 17 and the free end 20 of the other contact part 17 is formed to be wider than the width between the pair of LED unit locking parts 15.

In FIGS. 4A and 5, the electric wire connecting parts 11 are formed as parts to connect electric wires 40. The electric wire connecting part 11 in the present embodiment is constructed by a pair of pressing blades 22 which are formed to rise generally perpendicular to the busbars 4 to 7. When the busbars 4 to 7 are arranged as shown in FIG. 4A, the electric wire connecting parts 11 are arranged so that the positions of the electric wire connecting parts 11 shift mutually in the front-back direction. The pressing blades 22 are formed with generally U-shaped pressing grooves 23 which are cut downwards from the upper end edges of the pressing blades 22.

In FIG. 4A, the busbar locking parts 21 are formed as parts to lock the busbars 4 to 7 to the housing 8. The busbar locking parts 21 in the present embodiment have an arrow shape whose distal end is cut, and are formed at the sides of the front ends and the back ends of the busbars 4 to 7, one for each end. The busbar locking parts 21 are formed generally perpendicular to the busbars 4 to 7 from the lower sides of the busbars 4 to 7.

In FIG. 6, the housing 8 is formed into a generally board-like shape as shown in the figure by injection molding synthetic resin material that is insulative. The housing 8 is formed to have such a size that the busbars 4 to 7 can be accommodated on the top surface. The housing 8 includes an electric wire arranging part 24, and an LED unit arranging part 25 that follows the electric wire arranging part 24. On the top surface of the housing 8, busbar locking parts 26 which are locked with the busbar locking parts 21 are formed. The busbar locking parts 26 are formed in accordance with the positions and numbers of the busbar locking parts 21 formed in the busbars 4 to 7. A lock part 27, which is cut into a generally U-like shape, is formed at the front end of the housing 8 to assemble and lock the cover 3. Further, a lock part (not shown in the figure), which is cut into a generally U-like shape, is also formed at the back end of the housing 8 to assemble and lock the cover 3.

In FIG. 6, the LED unit arranging part 25 is formed convexly from the back end of the electric wire arranging part 24, and a generally U-shaped wall is formed around the circumference of the top surface. The LED unit arranging part 24 is formed as a part where the LED unit mounting part 12 of the busbars and the LED unit 9 are arranged.

In FIGS. 1 and 2, the cover 3 is formed in accordance with the shape of the unit subassembly 2. In FIG. 7A, the opening part 28, which is cut into a rectangular shape, is formed at the top surface of the cover 3 at the side of the back end. The housing 28 is formed in accordance with the mounting position of the LED unit 9 to make the illumination light that is emitted from the LED unit 9 pass (refer to FIG. 1). In FIG. 7B, the width of the opening part 28 is formed to be smaller than the width between the free end 20 of one contact part 17 and the free end 20 of the other contact part 17 in the pair of LED unit locking parts 15 (refer to FIG. 1). That is, the contact parts 17 are formed so that the free end 20 of one contact part 17 and the free end 20 of the other contact part 17 are located right under a fringe 29 of the opening part 28 when the cover 3 is assembled. With the construction and structure of the cover 3, the contact parts 17 will not pass through the opening part 28 and project beyond the cover 3. Therefore, the contact parts 17 abut with the fringe 29 of the opening part 28 inside the cover 3 surely. In FIG. 7B, the fringe 29 of the opening part 28 is formed to extend to a tapered shape at the inner side of the cover 8 from the side surfaces of the cover 8 towards ends 30 of the opening part 28. That is, at the inner surface of the housing 28 at the inner side of the cover 8, a section is formed into a generally V-like shape. With the above construction and structure, when the cover 3 is assembled to the housing 8, the fringe 29 of the opening part 28, which is formed into a tapered shape at the inner side of the cover 3, abuts with the contact parts 17 in a point-contact state.

In FIG. 7A, a locking part 31 is formed at the front end of the cover 3. The locking part 31 is formed to be locked to the locking part 27 at the front end of the unit subassembly 2. A locking part (not shown in the figure), which is locked to the locking part (not shown in the figure) at the back end of the unit subassembly 2, is formed at the back end of the cover 3. A slit 32 is formed at the right surface of the cover 3 to draw out the electric wires 40. A slit (not shown in the figure) is also formed at the left side of the cover 3. The height of the slit 32 is formed in accordance with the diameter of the electric wires 40 (refer to FIG. 1). Therefore, when the cover 3 is assembled to the unit subassembly 2 in FIG. 1, since the slit 32 covers the electric wires 40, the electrical connection of the electric wires 40 is prevented from dropping.

Then, with reference to FIGS. 8A to 10B, steps of assembling the unit subassembly 2 in the present embodiment are described. In FIG. 8A, first, the busbar locking parts 21 of the busbars 4 to 7 are locked by being inserted into predetermined busbar locking parts 26 as shown with thin line arrows. Thereby, the busbars 4 to 7 are fixed onto the top surface of the housing 8 (refer to FIG. 8B). Then, in FIG. 8B, the LED unit 9 is inserted into the LED unit mounting part 12 towards the direction as shown with a white arrow B.

In FIG. 9A, when the LED unit 9 is started to be inserted into the LED unit mounting part 12 towards the direction shown with the white arrow B, the LED unit 9 is slid on the slants 18 of the pressing parts 16 at the side where the LED unit 9 is inserted. When the LED unit 9 is just pushed in the direction shown with the white arrow B, the pressing parts 16 deform (flex) in the directions shown with black arrows C, and the width between the vertexes of the pressing parts 16 is enlarged. When the pressing parts 16 deform (flex) until the width between the vertexes of the pressing parts 16 becomes the same as the width of the LED unit 9, the LED unit 9 passes the pressing parts 16.

In FIG. 9B, when the LED unit 9 passes the pressing parts 16, the deformation (flex) of the pressing parts 16 is reversed, and the pressing parts 16 return in the direction shown with black arrows D and restore to the original shape by elasticity. Then, the LED unit side contacts 10a to 10f of the LED unit 9 at the bottom side abut with the electric connecting part 13 (the busbar side contacts 14a to 14f). The slants 19 of the pressing parts 16 at the side of the electric connecting part 13 abut with the two edges of the top surface of the LED unit 9. Thereby, the LED unit 9 is sandwiched and held by the pair of LED unit locking parts 15, and the LED unit 9 is mounted into the LED unit mounting part 12. By the above, the assembling of the unit subassembly 2 shown in FIGS. 10A and 10B is completed.

Steps that are reverse to the above steps are performed to remove the LED unit 9 from the LED unit locking parts 15. That is, when the LED unit 9, which is locked in the LED unit locking parts 15, is raised toward the direction which is reverse to the direction shown with the white arrow B in FIG. 9A, the LED unit 9 is slid on the slants 19 of the pressing parts 16 at the side of the electric connecting part 13, and the pressing parts 16 deform (flex) in the direction shown with the black arrows C in FIG. 9A. When the pressing parts 16 deform (flex), the width between the vertexes of the pressing parts 16 is enlarged so that the LED unit 9 can pass. When the LED unit 9 passes the pressing parts 16, the LED unit 9 is removed. At the same time, the deformation (flex) of the pressing parts 16 is reversed, and the pressing parts 16 return in the direction shown with the black arrows D and restore to the original shape in FIG. 9A.

In FIG. 11A, when the LED unit 9 is mounted in the LED unit mounting part 12, the LED unit side contacts 10a to 10f and the busbar side contacts 14a to 14f are connected. In FIG. 11B, among the busbar side contacts 14a to 14f, the LED unit side contact 10b to 10d are connected to the busbar side contacts 14b to 14d in the busbar 5, and the LEDs 9a to 9c are commonly connected to the plus side (the battery side not shown in the figure). The LED unit side contact 10a is connected to the busbar side contacts 14a in the busbar 4. The LED unit side contact 10e is connected to the busbar side contacts 14e in the busbar 6. The LED unit side contact 10f is connected to the busbar side contacts 14f in the busbar 7. Therefore, the LEDs 9a to 9c are connected to the minus side (the ground side not shown in the figure) individually, respectively.

In FIG. 12A, the assembly of the electric wires 40 to the unit subassembly 2 is performed towards a direction shown with a white arrow A. The assembly of the electric wires 40 is performed by pressing the electric wires 40 with pressure to the electric wire connecting parts 11. When the electric wires 40 including conductors (not shown in the figure) and insulated sheath 41 are pressed into the pressing grooves 23 of the pair of pressing blades 22, the pressing grooves 23 cut into the insulated sheath 41, and the pressing grooves 23 and the conductors 41 are pressed and connected. Thereby, in FIG. 12B, the unit subassembly 2 and the electric wire connecting parts 11 are electrically connected, and the electrical connection from outside to the unit subassembly 2 is performed.

Next, with reference to FIG. 13, the assembly of the cover 3 to the unit subassembly 2 is described. In FIG. 13, the cover 3 is assembled downwards to the unit subassembly 2. When the unit subassembly 2 and the cover 3 are assembled, the locking part 31 of the cover 3 is locked to the locking part 27 of the housing 8. The locking part, which is formed at the back end of the cover 3 and not shown in the figure, is locked to the locking part which is formed at the back end of the housing 8 and not shown in the figure. By the above, the assembly of the cover 3 to the unit subassembly 2 is completed.

Next, with reference to FIGS. 14 and 15, it is described in detail that the LED unit 9 is pressed in by the pressing parts 16 with the assembly of the cover 3 to the unit subassembly 2. In FIG. 14, when the cover 3 is to be assembled to the unit subassembly 2, the fringe 29 of the opening part 28 at the inner side of the cover 3 gradually approaches the contact parts 17 in the LED unit locking parts 15 at the side of the unit subassembly 2 towards a direction shown with a white arrow A.

In FIG. 15, when the cover 3 is assembled to the unit subassembly 2, the fringe 29 of the opening part 28 at the inner side of the cover 3 abuts with the contact parts 17 of the pair of LED unit locking parts 15, and pushes the contact parts 17. Because the width of the opening part 28 is formed to be smaller than the width between the free end 20 of one contact part 17 and the free end 20 of the other contact part 17, the fringe 29 of the opening part 28 is formed to extend so that the ends 30 are right above the contact parts 17 when the cover 3 is assembled to the unit subassembly 2. With the construction and structure of the above cover 3, even if the cover 3 is assembled to the unit subassembly 2, the contact parts 17 will not pass through the opening part 28 and project beyond the cover 3. Therefore, the fringe 29 of the opening part 28 abuts with the contact parts 17 surely.

In FIGS. 14 and 15, since the fringe 29 of the opening part 28 at the inner side of the cover 3 is formed to extend into a tapered shape towards the ends 30 of the opening part 28 from the side surfaces of the cover 3, when the cover 3 is assembled to the unit subassembly 2, the fringe 29 of the opening part 28 at the inner side of the cover 3 abuts with the free ends 20 of the contact parts 17 in a point-contact way (refer to FIG. 15). In FIG. 15, forces, with which the contact parts 17 are pressed inwards towards a direction shown with white arrows B, act. Therefore, the contact parts 17 can be pressed inwards with larger forces, in comparison with that the fringe 29 of the opening part 28 at the inner side of the cover 3 is formed parallel to the fringe 29 of the opening part 28 on the top surface of the cover 3.

In FIG. 15, when the fringe 29 of the opening part 28 pushes the contact parts 17, the pressing parts 16 deform (flex), and the slants 19 in the pressing part 16 are pressed inwards in the direction shown with white arrows C. Thereby, two ends on the top surface of the LED unit 9 are pressed inwards by the slants 19. A component force of the forces, with which the pressing parts 16 press inwards the LED unit 9, acts in the direction shown with a black arrow D. Then, the bottom side of the LED unit 9 is always kept pressing the electric connecting part 13 (the busbar side contacts 14a to 14f). Therefore, the electrical connection of the LED unit side contacts 10a to 10f in the LED unit 9 and the busbar side contacts 14a to 14f constructing the electric connecting part 13 can be maintained surely.

As described above with reference to FIGS. 1 to 15, according to the illuminating unit 1 in the present embodiment, the member for maintaining an electrically connected state of the LED unit side contacts 10a to 10f in the LED unit 9 and the busbar side contacts 14a to 14f constructing the electric connecting part 13 need not be produced separately, and an operation of assembling the related member becomes needless. Therefore, operativity related to the manufacture of the illuminating unit 1 is improved, and the manufacture cost can be reduced.

In addition, according to the illuminating unit 1, when the LED unit 9 is inserted into the LED unit locking parts 15, the LED unit 9 is slid on the slants 18, and the pressing parts 16 deform (flex). When the pressing parts 16 deform (flex), the width between the vertexes of the pressing parts 16 is enlarged so that the LED unit 9 can pass. When the LED unit 9 passes the pressing parts 16, the deformation (flex) of the pressing parts 16 is reversed, and the pressing parts 16 restore to the original shape. The slants 19 abut with the LED unit 9, and the LED unit 9 is sandwiched and held in the LED unit locking parts 15. When the LED unit 9, which is locked in the LED unit locking parts 15, is raised, the LED unit 9 is slid on the slants 19 so that the LED unit locking parts 15 deform (flex). When the pressing parts 16 deform (flex), the width between the vertexes of the pressing parts 16 is enlarged so that the LED unit 9 can pass. When the LED unit 9 passes the pressing parts 16, the LED unit 9 is removed while the deformation (flex) of the pressing parts 16 is reversed, and the pressing parts 16 restore to the original shape. Thereby, because the LED unit 9 can be locked in the LED unit locking parts 15 with a simple structure and a simple method, soldering becomes needless, and the mounting of the LED unit 9 becomes easy. Further, the LED unit 9 can be easily removed. Therefore, an effect is achieved that the manufacture-related operativity can be improved.

When the cover 3 is assembled, the free ends 20 of the contact parts 17 are located right under the fringe 29 of the opening part 28. Thereby, when the cover 3 is assembled to the housing 8, the contact parts 17 abut with the fringe 29 of the opening part 28 surely, and will not pass through the opening part 28 and project beyond the cover 3. Thereby, the contact parts 17 are pushed surely, and the pressing parts 16 deform (flex). Therefore, the LED unit 9 can be pressed inwards more surely by the pressing parts 16.

When the cover 3 is assembled to the housing 8, the fringe 29 of the opening part 28, which is formed into a tapered shape at the inner side of the cover 3, abuts with the contact parts 17 in a point-contact way. Thereby, the contact parts 17 can be pushed inwards with larger forces, in comparison with that the fringe 29 of the opening part 28 at the inner side of the cover 3 is formed parallel to the fringe 29 of the opening part 28 on the top surface of the cover 3. The pressing parts 16 deform (flex) so that the LED unit 9 can be pressed inwards with larger forces. Therefore, an electrically connected state of the LED unit 9 can be maintained more surely.

In addition, it is apparent that various modifications may be made to the invention without changing the purpose of the invention.

There is provided an illuminating capable of reducing man-hour related to the manufacture, the number of components and the manufacture cost, and improving workability, by adopting a simple structure.

What is claimed is:

1. An illuminating unit comprising
an electronic component that emits illumination light;
a busbar that includes a electric connecting part which electrically connects the electric component and the outside of the electronic component, and a locking part which has elasticity and sandwiches and holds the electronic component;
a housing that accommodates the busbar; and
a cover that is assembled to the housing and includes an opening part through which the illumination light passes,
wherein the locking part includes:
a contact part that abuts with a fringe of the opening part when the cover is assembled to the housing; and
a pressing part that follows the contact part and presses the electronic component by being deformed in a state where the cover is assembled to the housing.

2. The illuminating unit according to claim 1, wherein a shape of a cross section of the pressing part is convex, and
the pressing part is provided with a pair of slants.

3. The illuminating unit according to claim 1, wherein the contact part includes a first contact part having a first free end and a second contact part having a second free end, and
a width between the first free end and the second free end is wider than a width of the opening part.

4. The illuminating unit according to claim 1, wherein the fringe of the opening part at the inner side of the cover is formed into a tapered shape from a side face of the cover toward an edge of the opening part.

5. The illuminating unit according to claim 2, wherein the contact part includes a first contact part having a first free end and a second contact part having a second free end, and
a width between the first free end and the second free end is wider than a width of the opening part.

6. The illuminating unit according to claim 2, wherein the fringe of the opening part at the inner side of the cover is formed into a tapered shape from a side face of the cover toward an edge of the opening part.
